(19) United States
(12) Patent Application Publication
(10) Pub. No.: US 2014/0095404 A1
(43) Pub. Date: Apr. 3, 2014

(54) System and Method for Social Giving

(71) Applicant: Daniel Emanuel Hines, London (CA)

(72) Inventor: Daniel Emanuel Hines, London (CA)

(21) Appl. No.: 13/474,560

(22) Filed: May 17, 2012

(51) Int. Cl. G06Q 30/02

(52) U.S. Cl. CPC G06Q 30/0279
USPC 705/329

(57) ABSTRACT

A system for charitable giving. The system has a charitable network server that is operable to obtain from a transaction processing utility information relating to a transaction between a retailer and a user. The information corresponds to a donation amount to be directed from the retailer to a charity by the user.

### FIELD OF THE INVENTION

The present invention relates to social giving.

### DESCRIPTION OF THE PRIOR ART

Retailers are increasingly of the view that social responsibility can be a significant factor in developing brand appreciation, thereby increasing sales. Retailers sometimes face difficulties in publicizing their social responsibility to attract consumers.

Charities, meanwhile, find it increasingly difficult to attract donors.

It is an object of the present invention to obviate or mitigate the above disadvantages.

### SUMMARY OF THE INVENTION

In one aspect, a system for charitable giving is provided, the system comprising a charitable network server operable to obtain from a transaction processing utility information relating to a transaction between a retailer and a user, said information corresponding to a donation amount to be directed from said retailer to a charity by said user.

### BRIEF DESCRIPTION OF THE DRAWINGS

Embodiments of the invention will now be describing by way of example only with reference to the accompanying drawings in which,

FIG. 1 is a block diagram of a system in accordance with the present invention;

FIG. 2 is a flowchart showing an example transaction;

FIG. 3 is a module for a web-based implementation of the present invention;

FIG. 3 is a module for a web-based implementation of the present invention;

FIG. 4 is a web page for a web-based implementation of the present invention; and

FIG. 5 is another web page for a web-based implementation of the present invention.

### DETAILED DESCRIPTION OF THE INVENTION

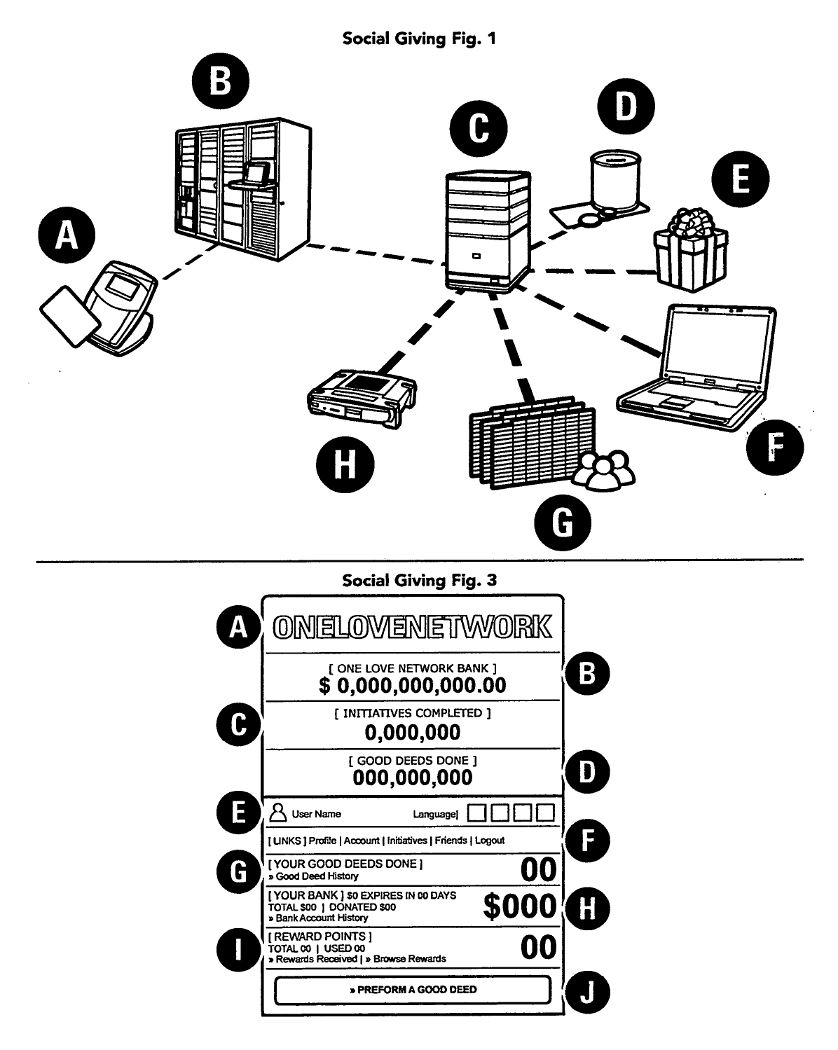

Referring to FIG. 1, a system comprising a charitable giving server (C) is shown. The charitable giving server comprises a processor and a non-transitory storage medium having computer instructions stored thereon that when executed by the processor are operable to provide the functionality described herein.

The charitable giving server (C) may be linked by network, such as the Internet, to one or more transaction processing utilities (B). Each transaction processing utility (B) may be operated by a payment clearing administrator, bank, or other financial institution that operates a network of one or more point of sale terminals (A).

The point of sale terminals (A) and transaction processing utility (B) enable payment to be made by a purchaser for a transaction between a purchaser and a retailer. In this regard, the point of sale terminals (A) and transaction processing utility (B) may be provided by a payment clearing administrator, bank, or other financial institution that operates the network of point of sale terminals (A) and may be operable for the purposes of enabling transactions regardless of whether a network link to the charitable giving server (C) exists. Alternatively, the transaction processing utility (B), any one or more of the point of sale terminals (A), or both may be provided by an administrator of the charitable giving server (A).

Each of the point of sale terminals (A) could be a barcode scanner, RFID reader, near field reader, magnetic card reader, smart card reader, or other device operable to obtain identification information from a token, such as a payment card or loyalty card, for example. The token could also be an alphanumeric string that can be manually entered into a point of sale terminal (A).

The charitable giving server (C) is further linked by network to one or more financial institution (D) that provide financial accounts to one or more charities. It should be understood that the term ‘charities’ is not intended to be limiting and could, alternatively, be a non-profit or for-profit entity or an individual, partnership, etc.

The charitable giving server (C) is also linked to a charity database (E), a retailer database (F) and a user database (G). The databases are operable to record data in a non-transitory storage medium, such as a magnetic disk or flash memory. The data comprises accounts, transactions, donations, credits, and network scores, each of which is described herein.

One or more client computers (F) are further linkable by network to the charitable giving server (C). Each of the client computers (F) can be accessed by a charity, a retailer, or a user to create, access and configure a charity account, retailer account, or user account, respectively. Client computers (F) may access the charitable giving server (C) by a network connected web server (H) that is linked to the charitable giving server (C) and is operable to serve web pages to the client computers (F) via the charitable giving server (C). Alternatively, the web server (H) could be accessible to the client computers (F) independently of the charitable giving server (C). The client computers (F) may execute a web browser application to interface with the web pages.

Client computers (F) may be any computing device, including desktop computers, laptop computers, smart phones, tablets, etc.

A charity account associates a charity with the charitable giving server (C). The charity account includes charity information comprising a charity identifier, financial account information enabling deposits to be credited to the charity (or, alternatively, information sufficient for an offline payment to be provided to the charity), and may further include a description of the charity and its charitable objectives. The charity information may further comprise the name of the charity.

The charity account may further be used to initiate one or more charitable initiatives. A charitable initiative enables donations to be directed by a user to a charity. A charity may initiate one charitable initiative that corresponds to all of the charities objectives.

Alternatively, the charity may initiate a plurality of charitable initiatives. For example, a charity that provides several distinct charitable objectives may wish to initiate a plurality of charitable initiatives. A specific example of such a charity would be a charitable organization that channels donations to a plurality of other charitable organizations. In this case, the first charitable organization may wish to initiate a plurality of charitable initiatives, each corresponding to one of the other charitable organizations.

Charity accounts and charity initiatives may be stored on the charity database (E) by the charitable giving server (C).

A retailer account associates a retailer with the charitable giving server (C). The retailer account includes retailer information comprising a retailer identifier, information sufficient to enable the charitable giving server (C) to link to the transaction processing utility (B) to obtain a record of the transactions made between the retailer and users, and one or more donation levels associated with transactions between the retailer and users. The retailer information may further comprise the retailer's name, brand name(s), logos, retail category, regions of operation, link to website.

The donation levels provide a metric by which donations will be directed from the retailer to one or more charities based on transactions made between the retailer and users.

The donation levels may correspond to a unit amount or a percentage of the transaction amount for each transaction with a user, for example. The donation level, for example, may be 1% of each transaction with a user. A plurality of donation levels may be configured by the retailer. For example, the retailer may provide a first donation level corresponding to transactions relating to a first product and a second donation level corresponding to transactions relating to a second product. Any number of donation levels could be configured.

The donation levels may further correspond to a unit amount or a percentage of transaction amounts related to combinations of products, time of sale, total amount of transaction, whether a product is pre-ordered, etc. Donation levels could also be user-dependent, such that different users could be associated with different donation levels. For example, particular attributes of a user could be a factor in the donation level.

Retailer accounts may be stored on the retailer database (F) by the charitable giving server (C).

The charitable giving server (C) is operable to obtain transaction information from the transaction processing utility (B) relating to the transactions between the retailer and users. The charitable giving server (C) may also be operable to direct funds from the transaction processing utility (B), or another financial institution, associated with the retailer, corresponding to donations based on these transactions to a financial institution (D) that provides a financial account for a charity. In this way, donations are sent to the charity.

The charitable giving server (C) may also generate retailer usage information for each retailer and link the retailer usage information to the corresponding retailer account. Retailer usage information may comprise the donations provided to date and the duration since creation of the retailer account.

Retailer usage information may be stored on the retailer database (F) by the charitable giving server (C).

Donations may be allocated to the charity by a user that is a purchaser or prospective purchaser.

Each user may create a user account with the charitable giving server (C). The user account includes user information comprising a user identifier, which may be a token that is readable by a point of sale terminal (A). The user information may also comprise the user's name, location, age and other demographic information.

The token could, for example, be a magnetic card, a smart card, a number to be entered into a point of sale terminal (A), a NFC, a RFID enabled card, etc.

The charitable giving server (C) associates a configurable number of donation units and may allocate a configurable number of credits with each user account.

User accounts may be stored on the user database (G) by the charitable giving server (C). In this regard, retailers or charities may be provided with demographic information of users, which could be provided for a fee payable to an administrator of the charitable giving server.

A user can access the charitable giving server (C) to identify charities that have created charity accounts in order to direct funds, associated with the number of donation units for that user, from a particular retailer with which it has transacted, to a financial institution (D) for that charity, or to the charity directly.

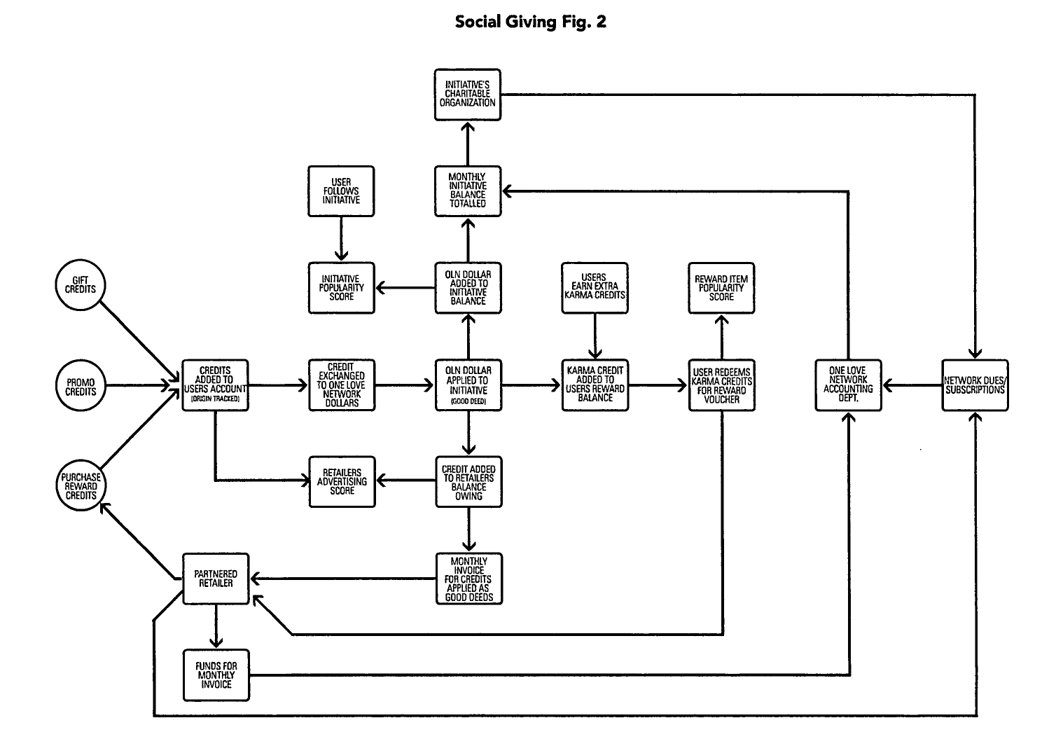

Referring, therefore, to FIG. 2, a user that has created a user account and is associated with a token may enter into a transaction with a retailer having a retailer account. The transaction is facilitated by a point of sale terminal (A) associated with the retailer. The transaction results in an amount of money being transferred from the user to the retailer. in accordance with known methods of transferring money by a point of sale terminal.

The charitable giving server (C), in real-time, near real-time, or on a periodic or arbitrary basis, obtains from the transaction processing utility (B) a set of transaction information regarding the transaction, including the retailer identifier of the retailer that entered into the transaction, amount of the transaction and user identifier of the user that entered into the transaction. Other information, such as the time that the transaction was entered into, may also be obtained. The transaction information may further include the retailer's location, which may be particularly useful where the retailer has multiple locations, whether the transaction was related to a promotion, method of payment, retailer's employee that executed the transaction, token type. It will be appreciated that further information that is linked to the transaction information, for example based on information stored in retailer accounts, could also be accessed by cross-referencing the transaction information with such further information.

Based on the transaction information, the charitable giving server (C) allocates donation units to the user account for that user. The donation units allocated are based on the corresponding donation level provided by the retailer for that transaction. Typically, the donation units are linked to particular legal monetary tender, which may be the local tender of the retailer.

In a specific example, a retailer provides a donation level of 1%. A particular transaction with a user is $100. The donation units are associated with dollars on a 1:1 basis. Therefore, the user is allocated 1 donation unit (being 1:1 of 1% of $100) for the transaction.

A user whose user account has been allocated donation units can then access the user account on the charitable giving server (C) to direct some or all of the user's donation units to one or more charities of the user's preference. The one or more charities may, for example, be selected by the user based on the description of the charity and its objectives as provided by each charity and stored on the charity database.

Directed donation units, being linked to legal monetary tender, can be converted by the charitable giving server (C) to an amount of the particular legal monetary tender. The charitable giving server (C) can withdraw this amount from the retailer's account with the transaction processing utility (C) and deposit the amount into the charity's account with its financial institution (D).

The withdrawals and deposits can be made upon a user directing donation units, or could be scheduled at preconfigured frequencies, such as daily, weekly, monthly, etc. to reduce transaction costs and bandwidth on the network.

Alternatively, an administrator of the charitable giving server (C) can invoice each retailer upon a user directing donation units, or at preconfigured frequencies, and obtain corresponding payment from the retailer. Furthermore, the administrator of the charitable giving server (C) can provide the charity with its amount of legal monetary tender by an offline method, such as by cheque.

The administrator may charge an administration fee, which could be a predetermined amount or percentage, for example, to the retailers, charities, or both. For example, the administrator may charge each retailer an administration fee that is based on the amounts of transactions on which donation units are based, and/or may charge each charity an administration fee that is based on the amounts donated to the charity.

Users may be incentivized to direct donation units by being rewarded by the charitable giving server (C) with credits. The number of credits rewarded may be linked to the amount of donation units donated, the elapsed time between the user being allocated the donation units and directing the donation units, user's network score, number of other users linked to the user in a social network, or any combination thereof. Other factors that may affect rewarding may be such things as, network achievements (badges), geo-location and check in status'. The credits may later be used by a user in exchange for rewards that are provided by any of the charities, retailers, administrator of the charitable giving server (C), or another party, such as a loyalty program.

A donation time limit may be configured by an administrator of the charitable giving server (C) for enabling a user to direct donation units to a charity. If the user does not direct the donation units to any charity within the donation time limit, the donation units may be directed to one or more charities of the administrator's choice, or may be directed to one or more charities based on an algorithm to determine a beneficiary. If the donation units are not directed to a charity within the donation time limit, the user may not be rewarded with credits.

Referring now to FIG. 3, an embodiment of the invention is shown wherein the charitable giving server (C) is accessible by a web frontend comprising one or more web pages that are served to client computers by the web server (H).

The web frontend provides a plurality of linked web pages providing contextual information and feeds in accordance with a charitable social network. User accounts, retailer accounts and charity accounts may be provided as charitable social network accounts and may be socially linkable among each other.

FIG. 3 more specifically shows a user's charitable social network account web page. The user's web page may comprise fields providing all users with information relating to the charitable causes for the charitable social network generally, including, for example, the charitable social network's branding (A), a cumulative total of the amount of donation units existing in the charitable social network (B) based on transactions, the cumulative number of charitable initiatives completed (C) using the charitable social network and the number of donations directed by users to charities (D) using the charitable social network.

The user's web page may also comprise user specific information. User specific information may comprise user name, language preference, and linked third-party social networks (E); a navigation pane enabling the user to access the user's profile, edit the user's account information, view a list of available charitable initiatives, view a list of friends that are other users on the charitable social network, and logout of the charitable social network (F); the number of donations directed by the user to charities using the charitable social network (G); the amount of donation units existing in the user's charitable social network account based on transactions involving the user (H); the number of credits available to the user (I); and a donation link (J).

The user's web pages may also include a social feed utility that provides the user with social feeds broadcast by other users, retailers, charities or partners and enables the user to broadcast social feeds to others, for example to discuss thoughts and concerns regarding social change. Users can also link their social network account to other users, retailers, charities and partners to follow those parties.

Third-party social networks may be linked to the charitable giving server (E) using application programming interfaces provided by the third-party social networks, including for the purpose of disseminating social feeds from the charitable social network. The social feeds may, for example, be text-based messages sent by the user, or automated messages that may include, for example, broadcasting the donation of donation units to charities or transacting with a retailer.

A user may, for example by clicking or otherwise selecting their number of donation units already directed to charities by the user, be provided with a list of the charitable initiatives to which the user has previously directed donation units.

A user may, for example by clicking or otherwise selecting their number of donation units available to be directed by the user, be provided with a list of the amounts of donation units received based on the particular transactions corresponding to those donation units.

A user may, for example by clicking or otherwise selecting the donation link (J), be directed to a web page listing available charitable initiatives to which the user can direct donation units.

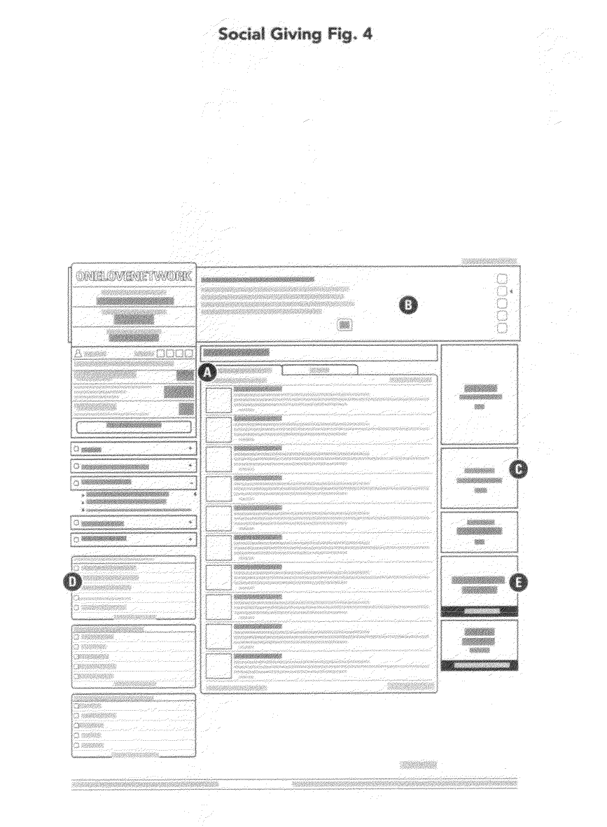

Referring therefore to FIG. 4, a web page listing available charitable initiatives to a user is, shown. The web page listing available charitable initiatives may comprise the information previously described in association with FIG. 3.

The listing of available charitable initiatives may be ranked and may also be searchable by the user (A). The listed available charitable initiatives may also be sortably displayed, based, for example, on featured initiatives, partnered initiatives, celebrity endorsed initiatives, goal proximity, alphabetical, date listed or category.

A summary may be displayed for each listing. The summary may comprise the initiative's goal, amount raised, amount required, and information on the initiative.

The web page listing available charitable initiatives may also display initiative network activity (D). Initiative network activity may comprise a plurality of activity modules, each having a title, a preconfigured number of listed elements which are linked to a related detail page and a link for the full listing of elements.

A first module may display the top 5 most popular initiatives and may include a link to see the full list of the initiatives by rank. A second module may display the 5 most in need initiatives, which may be determined based on a most in need score corresponding to the amount still outstanding versus the deadline for the initiative. A third module may display partnered initiatives listed by popularity.

A plurality of advertising modules may also be displayed on the web page listing available charitable initiatives.

A partnered initiative banner (B) may alternately display a preconfigured number of advertisements. The advertisements may correspond to a selected number of partnered initiatives, which may be selected randomly or in a predetermined sequence.

A set of merchant advertisements may also be provided (C). An enlightenment slogan and a reward package branded advertisement (E) may also be provided. The merchant advertisements may be unrelated to charitable initiatives and can be linked to external web sites. The merchant advertisements may be contextual advertisements based on user demographics.

The enlightenment slogan may display a background graphic and inspiring quote. Quotes may be selected from a database of “words of wisdom”. The reward package branded advertisement may be for a particular reward and the reward provider's name or branding. The reward package branded advertisement may be linkable to a reward package detail page that provides information corresponding to the rewards and enables redemption of rewards.

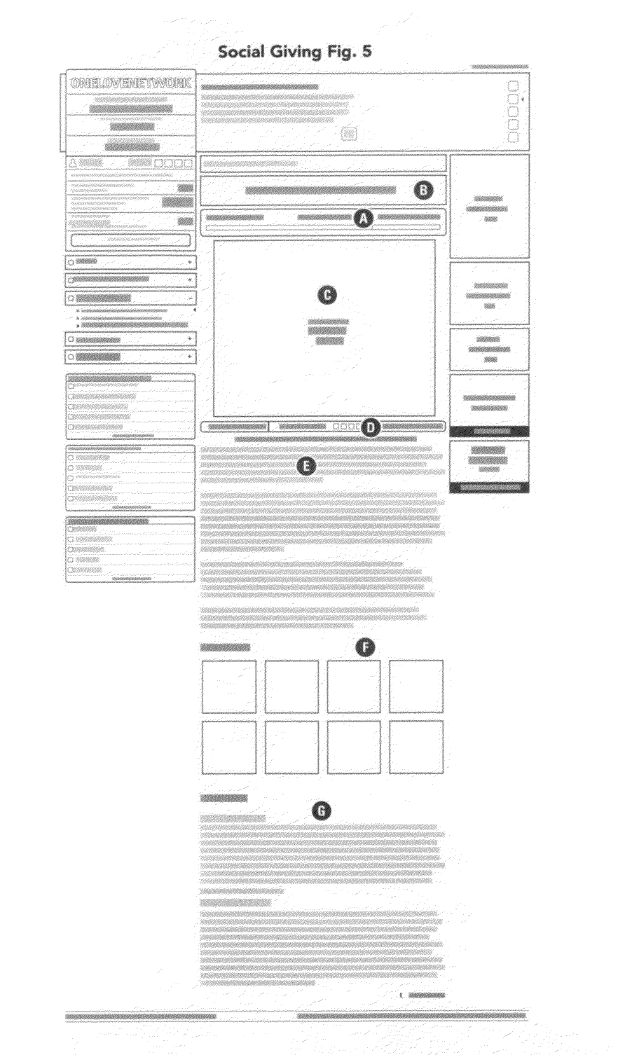

Referring now to FIG. 5, when an initiative is selected, the user is provided with an initiative detail page. The initiative detail page may comprise the information previously described in association with FIG. 3 and FIG. 4.

The initiative detail page may also comprise an initiative progress module (A) that displays the initiative's status, including amount of legal monetary tender raised, the legal monetary tender goal, the needed legal monetary tender amount and days remaining, which may also be provided by a progress bar or other graphical display that may have a particular colour indicating whether the goal has been reached to complete the initiative or if there is a critical need status. When an initiative has been completed, the initiative is added to the cumulative charitable initiatives achieved.

Web pages for partner initiatives may comprise brand information of the partner that may be linkable to the partner's profile page.

Further information that may be provided includes blogs, video blogs, initiative description, photos relating to the initiative as provided by users or charities, status updates provided by the charity, the partner or by users that are linked to the charity or partner.

Users may choose to donate to the initiative by clicking a link on the initiative detail page. Clicking the link prompts the user to enter a donation unit amount. Users may choose to “follow” an initiative, which enables users to monitor and provide status updates and social feeds for the initiative and to monitor the donation status for the initiative. Users that direct donations to a particular initiative may be automatically set to follow that initiative.

Retailers are provided with a retailer's web page. The retailer's web page enables the retailer to configure a retailer account. The retailer may also provide advertisements on the retailer's web page. The retailer's web page may further comprise a social feed, or comment wall, enabling users to provide comments about the retailer.

Operations on the social network may be affected by a network score corresponding to any or all of the users, retailers and charities. For example, when a user allocates a donation unit to a charity, the charitable giving server (C) may increase the network score of the user, retailer and/or charity by preconfigured amounts. A user's network score may also be influenced by the number of social contacts the user maintains or changes, the amount of content (such as blogs or video-blogs, for example) that the user contributes to the social network, etc.

The network score of a retailer may be determined based on the number of users that transact with the retailer in a given time period, the proportion of those users that subsequently allocate donation units to charities, the donation level of the retailer, the number of comments placed by users on the retailer's web page, etc.

The network score may be a factor enabling the charitable giving server (C) to determine how much exposure the users, retailers and/or charities receive on the social network. For example, retailers with higher network scores may be provided with more prominent or more frequent advertisements.

The charitable giving server (C) may generate a user leaderboard listing a preconfigured number of users having the highest network scores among all users. The leaderboard may be displayed on each user's web page, which may provide an incentive for users to seek to increase their network score.

The network score may also be used by the charitable giving server (C) to increase visibility of a user, retailers or charity on the social network. For example, the network score may be a factor in a scoring system that controls advertisement placement for retailers, users, charities and other partners, such as manufacturers. A higher network score may also be tied to virtual and/or real world achievements.

In a particular example, if a user A is able to have 100 other users join the social, network, donates 50 donation units to a charity, provides content on the social network and/or obtains positive feedback for that content, the charitable giving server (C) may reward the user with a virtual or real world achievement badge that provides the user with access to discounted gift merchandise and/or physical world VIP events.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A system for charitable giving comprising a charitable network server operable to obtain from a transaction processing utility information relating to a transaction between a retailer and a user, said information corresponding to a donation amount to be directed from said retailer to a charity by said user.
